(19) United States
(12) Patent Application Publication
(10) Pub. No.: US 2015/0315392 A1
(43) Pub. Date: Nov. 5, 2015

(54) COATING LIQUID FOR FORMING ALKALI BARRIER LAYER, AND ARTICLE

(71) Applicant: ASAHI GLASS COMPANY, LIMITED, Tokyo (JP)

(72) Inventors: Yoshimi OTANI, Tokyo (JP); Satoshi MOTOTANI, Tokyo (JP); Azusa TAKAI, Tokyo (JP)

(73) Assignee: ASAHI GLASS COMPANY, LIMITED, Tokyo (JP)

(21) Appl. No.: 14/799,711

(22) Filed: Jul. 15, 2015

Related U.S. Application Data
(63) Continuation of application No. PCT/JP2014/050579, filed on Jan. 15, 2014.

(30) Foreign Application Priority Data
Jan. 15, 2013 (JP) 2013-004618

(51) Int. Cl. C09D 7/12; C03C 17/34; C03C 17/25

(52) U.S. Cl. CPC C09D 7/1216; C09D 7/1233; C03C 17/25; C03C 17/34

(57) ABSTRACT

To provide a coating liquid for forming an alkali barrier layer which can achieve both suppress of warpage of a glass substrate and alkali barrier properties, and an article which comprises a glass substrate and an alkali barrier layer formed of the coating liquid on the glass substrate.

A coating liquid for forming an alkali barrier layer, which comprises at least one matrix precursor (A) selected from the group consisting of an alkoxysilane and its hydrolyzate, scaly silica particles (B) and a liquid medium (C), wherein the proportion of the content (solid content) of the scaly silica particles (B) is from 5 to 90 mass % based on the total amount of the matrix precursor (A) and the scaly silica particles (B).

### TECHNICAL FIELD

The present invention relates to a coating liquid for forming an alkali barrier layer, and an article having an alkali barrier layer on a glass substrate.

### BACKGROUND ART

By coating a substrate with a sol-gel silica solution obtained by hydrolyzing an alkoxysilane, followed by drying, a film containing silica as the main component is formed by condensation of a hydrolyzate of the alkoxysilane. A coating liquid having various functional fine particles added to the sol-gel silica solution has been used to impart various properties (for example, antistatic function and low-reflection) to a substrate coated with the coating liquid. Further, the sol-gel silica solution itself may be used as a coating liquid for forming an alkali barrier layer on a glass substrate surface.

In a photovoltaic module for example, to protect a solar cell, a cover glass is disposed on a front side and a back side of the solar cell, and as the cover glass, a cover glass having a low reflection film (AR film) formed on the surface of a glass substrate is used in many cases to increase the power generation efficiency. In such a case, for the purpose of improving the durability of the AR film, an alkali barrier layer may be provided at the interface between the AR film and the glass substrate. For formation of the alkali barrier layer, the above-described sol-gel silica solution is primarily used as the main coating liquid. Further, for formation of the AR film also, a sol-gel silica solution having functional fine particles added is used widely.

However, in a case where the sol-gel silica solution is applied to a substrate, the resulting film may shrink in a drying step after coating, thus leading to warpage of the substrate in some cases. The shrinkage of the film tends to be significant as the coating film is thicker and the film drying (baking) temperature is higher. Especially in a case where the substrate is a glass substrate, the glass substrate may be heated at high temperature (for example, from 600 to 700° C.) for tempering depending upon the purpose of use of the substrate. If heating at high temperature is carried out after application of the coating liquid, the film shrinkage tends to be more significant, and warpage of the glass substrate is more significant. Accordingly, the tempering conditions may be considerably restricted, or the yield of products may decrease due to warpage. Further, warpage of the glass substrate tends to be more significant as the glass substrate becomes thinner, and the problem of warpage may be a great obstacle to weight saving, that is, reduction in thickness, of the glass substrate.

The above problem arise also in a case where functional fine particles are added to the sol-gel silica solution.

Patent Document 1 discloses a colored coated film comprising a SiO₂ type base matrix comprising silica and colloidal silica formed of a Si-alkoxide as a precursor, and a colored metal oxide formed of a coloring metal salt as a precursor precipitated and dispersed in the base matrix, formed on at least one side of a transparent substrate such as a soda lime silica glass substrate, wherein the Si molar ratio Si-a/Si-c of Si in the Si-alkoxide (Si-a) to Si in the colloidal silica (Si—C) and the metal molar ratio ΣMi/T-Si of the total number of moles ΣMi of the metal in the colored metal oxide to the total number of moles T-Si of the above Si are respectively within specific ranges. Further, it discloses, as a method for its formation, a method of applying a coating liquid for forming a colored coating film to a substrate, followed by drying and baking at 550° C. or higher, wherein the coating liquid for forming a colored coating film contains a Si-alkoxide, colloidal silica, a coloring metal salt and a solvent, and the total Si molar concentration in the coating liquid is adjusted to be within a specific range. Patent Document 1 discloses that warpage of the transparent substrate at the time of baking can be suppressed by the above constitution.

### PRIOR ART DOCUMENT

### Patent Document

Patent Document 1: JP-A-2001-055527

### DISCLOSURE OF INVENTION

### Technical Problem

In formation of an alkali barrier layer on a glass substrate using a sol-gel silica solution, it is difficult to satisfy both suppression of warpage of the glass substrate and alkali barrier properties by conventional technique. For example, in a case where only a sol-gel silica solution is used, the obtainable film is excellent in the alkali barrier properties, however, warpage of the glass substrate tends to be significant.

By adding fine particles such as colloidal silica to the sol-gel silica solution as in Patent Document 1, although warpage of the glass substrate is less likely to occur, denseness of the obtainable film may be impaired by the fine particles, and the alkali barrier properties tend to be low.

Under these circumstances, the object of the present invention is to provide a coating liquid for forming an alkali barrier layer which satisfies both suppression of warpage of the glass substrate and alkali barrier properties, and an article, which comprises an alkali barrier layer formed by using the coating liquid on a glass substrate.

### Solution to Problem

The present inventors have conducted extensive studies and as a result, found that by adding scaly silica particles to a sol-gel silica solution, an excellent warpage suppression effect is obtained, and further, the obtainable film has alkali barrier properties different from those of a film obtained by addition of spherical silica particles such as colloidal silica, and may sufficiently function as an alkali barrier layer.

The present invention has been accomplished on the basis of the above discovery and provides the following.

[1] A coating liquid for forming an alkali barrier layer, which comprises at least one matrix precursor (A) selected from the group consisting of an alkoxysilane and its hydrolyzate, scaly silica particles (B) and a liquid medium (C),

wherein the proportion of the content (solid content) of the scaly silica particles (B) is from 5 to 90 mass % based on the total amount of the matrix precursor (A) and the scaly silica particles (B).

[2] The coating liquid for forming an alkali barrier layer according to the above [1], wherein the alkoxysilane is a compound represented by the following formula:

SiXₘY₄₋ₘ

wherein m is an integer of from 2 to 4, X is an alkoxy group, and Y is a non-hydrolyzable group.
[3] The coating liquid for forming an alkali barrier layer according to the above [1] or [2], wherein the scaly silica particles (B) have an average aspect ratio of from 50 to 650 and an average particle size of from 0.08 to 0.42 μm.
[4] The coating liquid for forming an alkali barrier layer according to any one of the above [1] to [3], wherein the scaly silica particles (B) are flaky silica primary particles having a thickness of from 0.001 to 0.1 μm, or silica secondary particles having a thickness of from 0.001 to 3 μm, formed by a plurality of flaky silica primary particles arranged and overlaid one on another so that their faces are in parallel with one another.
[5] The coating liquid for forming an alkali barrier layer according to the above [3] or [4], wherein the scaly silica particles (B) are produced by a process comprising a step of subjecting a silica powder containing silica agglomerates having scaly silica particles agglomerated to acid treatment at a pH of at most 2, a step of subjecting the acid-treated silica powder to alkali treatment at a pH of at least 8 to deflocculate the silica agglomerates, and a step of wet disintegrating the alkali-treated silica powder.
[6] The coating liquid for forming an alkali barrier layer according to any one of the above [1] to [5], wherein the liquid medium (C) is at least one member selected from the group consisting of water, an alcohol, a ketone, an ether, a cellosolve, an ester, a glycol ether, a nitrogen-containing compound and a sulfur-containing compound.
[7] The coating liquid for forming an alkali barrier layer according to any one of the above [1] to [6], wherein the content of the matrix precursor (A) as the solid content concentration (as calculated as SiO₂) is from 0.03 to 6.3 mass % based on the total mass of the coating liquid for forming an alkali barrier layer.
[8] The coating liquid for forming an alkali barrier layer according to any one of the above [1] to [7], wherein the total amount of the matrix precursor (A) and the scaly silica particles (B) as the solid content concentration (as calculated as SiO₂) is from 0.3 to 7 mass % based on the total mass of the coating liquid for forming an alkali barrier layer.
[9] An article, which comprises a glass substrate, and an alkali barrier layer formed of the coating liquid for forming an alkali barrier layer as defined in any one of the above [1] to [8] on the glass substrate.
[10] The article according to the above [9], wherein the alkali barrier layer has a film thickness of from 40 to 200 nm.
[11] The article according to the above [9] or [10], wherein the glass substrate has a thickness of at most 15.0 mm.
[12] The article according to any one of the above [9] to [11], which further has another layer different from the alkali barrier layer on the alkali barrier layer.
[13] The article according to the above [12], wherein said another layer contains a low reflection film.
[14] The article according to any one of the above [9] to [13], which is subjected to baking treatment at from 100 to 700° C. at the time of forming or after forming the alkali barrier layer.

### Advantageous Effects of Invention

According to the present invention, it is possible to provide a coating liquid for forming an alkali barrier layer which can satisfy both suppression of warpage of a glass substrate and alkali barrier properties, and an article which comprises a glass substrate and an alkali barrier layer formed of the coating liquid on the glass substrate.

### BRIEF DESCRIPTION OF DRAWING

FIG. 1 is a TEM photograph of silica agglomerates (after wet disintegration) contained in a scaly silica particle dispersion (β) used in Examples of the present invention.

### DESCRIPTION OF EMBODIMENTS

### Coating Liquid for Forming Alkali Barrier Layer

The coating liquid for forming an alkali barrier layer of the present invention (hereinafter sometimes referred to simply as “a coating liquid”) comprises at least one matrix precursor (A) selected from an alkoxysilane and its hydrolyzate (hereinafter sometimes referred to as “component (A)”), scaly silica particles (B) (hereinafter sometimes referred to as “component (B)”) and a liquid medium (C), wherein the proportion of the content (solid content) of the component (B) is from 5 to 90 mass % based on the total amount of the component (A) and the component (B).

### [Component (A)]

An alkoxysilane is a compound having hydrogen atom(s) in silane (SiH₄) substituted with substituent(s), wherein at least one substituent is an alkoxy group. A hydrolyzate of the alkoxysilane is a compound having a structure such that the alkoxy group bonded to Si of the alkoxysilane is converted by hydrolysis to a OH group. The hydrolyzate of the alkoxysilane may form a condensate by condensation of hydrolyzate molecules.

The alkoxysilane may be a known alkoxysilane used for e.g. formation of an alkali barrier layer, for example, a compound represented by SiXₘY₄₋ₘ (wherein m is an integer of from 2 to 4, X is an alkoxy group, and Y is a non-hydrolyzable group).

The alkoxy group as X has from 1 to 4, more preferably from 1 to 3 carbon atoms.

m is preferably 3 or 4.

The non-hydrolyzable group as Y is a functional group of which the structure does not change under conditions under which the Si—X group is converted to the Si—OH group by hydrolysis. The non-hydrolyzable group is not particularly limited and may be a group known as a non-hydrolyzable group in e.g. a silane coupling agent.

The alkoxysilane may, for example, be specifically a tetraalkoxysilane (such as tetramethoxysilane, tetraethoxysilane, tetrapropoxysilane or tetrabutoxysilane), an alkoxysilane having an alkyl group (such as methyltrimethoxysilane, methyltriethoxysilane, ethyltrimethoxysilane, ethyltriethoxysilane, propyltrimethoxysilane, propyltriethoxysilane, decyltrimethoxysilane or decyltriethoxysilane), an alkoxysilane having an aryl group (such as phenyltrimethoxysilane or phenyltriethoxysilane), an alkoxysilane having a perfluoropolyether group (such as perfluoropolyether triethoxysilane), an alkoxysilane having a perfluoroalkyl group (such as perfluoroethyltriethoxysilane), an alkoxysilane having a vinyl group (such as vinyltrimethoxysilane or vinyltriethoxysilane), an alkoxysilane having an epoxy group (such as 2-(3,4-epoxycyclohexyl)ethyltrimethoxysilane, 3-glycidoxypropyltrimethoxysilane, 3-glycidoxypropylmethyldiethoxysilane or 3-glycidoxypropyltriethoxysilane), or an alkoxysilane having an acryloyloxy group (such as 3-acryloyloxypropyltrimethoxysilane). The alkoxysilane is preferably a tetraalkoxysilane, an alkoxysilane having an alkyl group, or the like. They may be used alone or in combination of two or more.

Hydrolysis of the alkoxysilane may be carried out by a conventional method. Usually, it is carried out with water in such an amount that all the alkoxy groups bonded to Si of the alkoxysilane can be hydrolyzed (in the case of a tetraalkoxysilane for example, water in an amount of 4 times or more the mole of the tetraalkoxysilane) and an acid or an alkali as a catalyst. The acid may, for example, be an inorganic acid such as HNO₃, H₂SO₄ or HCl, or an organic acid such as formic acid, oxalic acid, monochloroacetic acid, dichloroacetic acid or trichloroacetic acid. The acid is preferably nitric acid, hydrochloric acid, oxalic acid or the like.

The alkali may, for example, be ammonia, sodium hydroxide or potassium hydroxide. The catalyst is preferably an acid in view of long term storage property.

The coating liquid may contain one type or two or more types of the component (A).

The content of the component (A) in the coating liquid is not particularly limited so long as the coating liquid can be applied, and the content as the solid content concentration (as calculated as SiO₂) is preferably from 0.03 to 6.3 mass %, more preferably from 0.05 to 3.0 mass % based on the total mass of the coating liquid. When the solid content concentration of the component (A) is at least 0.03 mass %, the amount of the coating liquid to be used for formation of the alkali barrier layer can be reduced. When the solid content concentration of the component (A) is at most 6.3 mass %, uniformity of the film thickness of the alkali barrier layer to be formed will improve.

Here, the solid content of the component (A) is an amount assuming that the entire Si of the component (A) is converted to SiO₂ (solid content as calculated as SiO₂).

### [Component (B)]

The component (B) is scaly silica particles.

“Scale silica particles” are flaky silica primary particles or silica secondary particles formed by a plurality of flaky silica primary particles arranged and overlaid one on another so that their faces are in parallel with one another. The silica secondary particles are usually in the form of particles having a layered structure.

The shape of the particles may be confirmed by a transmission electron microscope (hereinafter sometimes referred to simply as “TEM”).

The ratio of the minimum length to the thickness of each of the silica primary particles and the silica secondary particles is preferably at least 2, more preferably at least 5, particularly preferably at least 10.

The thickness of the silica primary particles is preferably from 0.001 to 0.1 μm, more preferably from 0.002 to 0.1 μm. Such silica primary particles may be arranged so that their faces are in parallel with one another to form one scaly silica secondary particle or a plurality of scaly silica secondary particles overlaid one on another.

The thickness of the silica secondary particles is preferably from 0.001 to 3 μm, more preferably from 0.005 to 2 μm.

The silica secondary particles are preferably present independently without being fused.

The component (B) contained in the coating liquid of the present invention may be either one or both of the silica primary particles and the silica secondary particles.

The average aspect ratio of the component (B) is preferably from 50 to 650, more preferably from 100 to 350, further preferably from 170 to 240. When the average aspect ratio of the entire component (B) contained in the coating liquid of the present invention is at least 50, favorable alkali barrier properties will be obtained, and when it is at most 650, the dispersion stability of the coating liquid tends to be favorable.

In the present invention, “the aspect ratio” means a ratio (maximum length/thickness) of the maximum length to the thickness of each particle, and “the average aspect ratio” is an average of the aspect ratios of 50 particles randomly selected. The thickness of the particles is measured by an AFM (atomic force microscope), and the maximum length is measured by a TEM.

The average particle size of the component (B) is preferably from 0.08 to 0.42 μm, more preferably from 0.17 to 0.21 μm. When the average particle size of the entire component (B) contained in the coating liquid of the present invention is at least 0.08 μm, favorable alkali barrier properties will be obtained, and when it is at most 0.42 μm, the dispersion stability of the coating liquid tends to be favorable.

In the present invention, “the average particle size” is a value measured by a laser diffraction/scattering type particle size distribution measuring apparatus and is a volume average value (D50).

The silica purity of the component (B) is preferably at least 95.0 mass %, more preferably at least 99.0 mass %.

For preparation of the coating liquid of the present invention, a powder which is agglomerates of a plurality of scaly silica particles, or a dispersion having the powder dispersed in a medium is used. The silica concentration in the silica dispersion is preferably from 1 to 80 mass %, more preferably from 4 to 40 mass %.

The powder or the dispersion may contain, in addition to the scaly silica particles, irregular silica particles which form at the time of production of the scaly silica particles.

The scaly silica particles are obtained, for example, by disintegrating and dispersing silica agglomerates formed by aggregation of scaly silica particles.

The irregular silica particles are in a state where the silica agglomerates are disintegrated to a certain extent but are not disintegrated to individual scaly silica particles, and are in a state where a plurality of scaly silica particles form an agglomerate. If the irregular silica particles are contained, the denseness of the obtainable film may be decreased and the alkali barrier properties may be impaired. Accordingly, the content of the irregular silica particles in the powder or the dispersion is preferably as low as possible.

The irregular silica particles and the silica agglomerates appear black by observation with a TEM. On the other hand, the flaky silica primary particles and the silica secondary particles appear transparent or translucent by observation with a TEM.

The component (B) may be a commercially available product or may be prepared.

The component (B) is preferably one produced by the after-mentioned production process (P). According to the production process (P), formation of the irregular silica particles in the production step is suppressed, and a powder or a dispersion having a low content of the irregular silica particles will be obtained as compared with a known production process (for example, a process as disclosed in Japanese Patent No. 4,063,464).

The content of the component (B) in the coating liquid of the present invention is such an amount that the proportion of the content (solid content) of the component (B) based on the total amount of the component (A) and the component (B) is from 5 to 90 mass %. The proportion is preferably from 10 to 80 mass %, more preferably from 10 to 60 mass %. When the proportion of the component (B) based on the total amount of the component (A) and the component (B) is at least 5 mass %, an effect to suppress warpage of the glass substrate is sufficiently exhibited, and when the proportion is at most 90 mass %, the film to be formed of the coating liquid has alkali barrier properties sufficient as an alkali barrier layer.

The content of the component (B) is measured by an infrared moisture meter.

The total amount of the component (A) and the component (B) in the coating liquid of the present invention is not particularly limited so long as the coating liquid can be applied, and the total amount as the solid content concentration based on the total mass of the coating liquid is preferably from 0.3 to 7 mass %, more preferably from 0.5 to 5 mass %. When the solid content concentration is at least 0.3 mass %, the amount of the coating liquid may be reduced, and when it is at most 7 mass %, uniformity of the film thickness of the obtainable alkali barrier layer will improve.

### (Process (P) for Producing Scaly Silica Particles)

The production process (P) comprises a step of subjecting a silica powder containing silica agglomerates having scaly silica particles agglomerated to acid treatment at a pH of at most 2, a step of subjecting the acid-treated silica powder to alkali treatment at a pH of at least 8 to deflocculate the silica agglomerates, and a step of wet disintegrating the alkali-treated silica powder to obtain scaly silica particles.

Here, the silica agglomerates having the scaly silica particles agglomerated are silica tertiary particles in the form of porous disorderly agglomerates of scaly silica particles.

The irregular silica particles are particles such that the silica agglomerates are disintegrated to a certain extent, however, they are not disintegrated to individual scaly silica particles, and a plurality of scaly silica particles form an agglomerate.

As the silica agglomerates having the scaly silica particles agglomerated, so-called layered polysilicic acid and/or its salt may be used. Here, the layered polysilicic acid is polysilicic acid having a silicate layer structure having SiO₂ tetrahedrons as the primary structural units.

The layered polysilicic acid and/or its salt may, for example, be silica-X (SiO₂—X), silica-Y (SiO₂—Y), kenyaite, magadiite, makatite, ilerite, kanemite or octosilicate. Among them, silica-X and silica-Y are preferred.

Each of silica-X and silica-Y is an intermediate or metastable phase formed in the process of subjecting silica materials to hydrothermal treatment to form cristobalite or quartz, and is a weak crystalline phase which may be considered as quasicrystalline substance of silica.

Silica-X and silica-Y are different in X-ray diffraction pattern, but they are very similar to each other in the particle outer appearance as observed by an electron microscope, and both can be preferably used to obtain the scaly silica particles. The X-ray diffraction spectrum of silica-X is characterized by the main peaks at 2θ=4.9°, 26.0° and 28.3° corresponding to ASTM (American Society for Testing and Materials) card (hereinafter referred to simply as ASTM card) number 16-0380 registered in the USA.

The X-ray diffraction spectrum of silica-Y is characterized by the main peaks at 2θ=5.6°, 25.8° and 28.3°, corresponding to ASTM card number 31-1233.

The X-ray diffraction spectrum of the silica agglomerates is preferably characterized by such main peaks of silica-X and/or silica-Y.

### [Formation of Silica Powder]

As an example of the method of forming the silica powder, at least one member selected from the group consisting of a silica hydrogel, a silica sol and hydrous silicic acid is subjected to hydrothermal treatment in the presence of an alkali metal salt to form a silica powder containing agglomerates having scaly silica particles agglomerated. The silica powder is not limited to one produced by this method and may be formed by any method.

In a case where a silica hydrogel is used as the starting material, silica-X, silica-Y or the like as the silica agglomerates can be produced in a high yield at a low temperature in a short time without formation of crystals such as quartz.

The silica hydrogel is preferably silica hydrogel particles, and they may be spherical or have irregular shapes and may be formed by an appropriately selected granulation method.

For example, spherical silica hydrogel may be formed by solidifying silica hydrosol into a spherical shape in a medium such as a petroleum solvent, but it is preferably formed by ejecting a sol formed by mixing an aqueous alkali metal silicate solution and an aqueous mineral acid solution into a medium gas so that a silica sol is formed in a short time simultaneously with the conversion of the sol into a gel in the gas. The aqueous mineral acid solution may, for example, be sulfuric acid, hydrochloric acid or nitric acid, preferably sulfuric acid.

That is, an aqueous alkali metal silicate solution and an aqueous mineral acid solution are introduced into a container equipped with a nozzle from different inlets and uniformly mixed instantaneously to form a silica sol having a pH of from 7 to 9 and a concentration of at least 130 g/L as calculated as SiO₂, and the silica sol is ejected from the nozzle into the medium gas such as air and is converted into a gel while it is flying. The obtained gel is let to dive into an aging tank containing water placed at their landing site and are aged for from a few minutes to a few tens minutes, an acid (such as sulfuric acid, hydrochloric acid or nitric acid) is added, followed by washing with water, to obtain a spherical silica hydrogel.

The silica hydrogel is transparent spherical particles having a uniform particle size with an average particle size of from about 2 to 10 mm and elasticity and contains, for example, about 4 times as much water as the weight of SiO₂ in some cases. The SiO₂ concentration in the silica hydrogel is preferably from 15 to 75 mass %.

In a case where the starting material is a silica sol, it is preferred to use a silica sol containing silica and an alkali metal in predescribed amounts.

As the silica sol, it is preferred to use a silica sol obtained by dealkalizing an aqueous alkali metal silicate solution having a silica/alkali metal molar ratio (SiO₂/Me₂O, wherein Me is an alkali metal such as lithium (Li), sodium (Na) or potassium (K); the same applies hereinafter) of from 1.0 to 3.4 (the ratio of the material; the following ratio is achieved by dealkalization) by ion exchange with a resin or by electrodialysis. A preferable aqueous alkali metal silicate solution may be obtained, for example, by diluting water glass (aqueous sodium silicate solution) with a suitable amount of water.

The silica/alkali metal molar ratio (SiO₂/Me₂O) of the silica sol is preferably within a range of from 3.5 to 20, more preferably within a range of from 4.5 to 18. Further, the SiO₂ concentration in the silica sol is preferably from 2 to 20 mass %, more preferably from 3 to 15 mass %.

The average particle size of the silica in the silica sol is preferably from 1 to 100 nm. If the average particles size exceeds 100 nm, the stability of the silica sol tends to deteriorate. The silica sol is particularly preferably so-called active silicic acid having an average particles size of from 1 to 20 nm.

In a case where hydrous silicic acid is used as the starting material, a silica powder containing silica agglomerates can be formed by the same method as in the case of the silica sol.

A silica source comprising the silica hydrogel, the silica sol, the hydrous silicic acid or a combination thereof is subjected to hydrothermal treatment in a heating pressure vessel such as an autoclave under heating in the presence of an alkali metal salt to form a silica powder containing silica agglomerates.

Further, prior to feeding the silica source into an autoclave for the hydrothermal treatment, purified water such as deionized water or distilled water may be added to adjust the silica concentration within a desired range.

In a case where the spherical silica hydrogel is used, it may be used as it is, or may be pulverized or roughly pulverized into a particle size of from about 0.1 to 6 mm.

Any type of autoclave may be used without special restrictions as long as it is equipped at least with a heating means and a stirring means, and preferably equipped further with a thermometric means.

The total silica concentration of the charged liquid in the autoclave is usually preferably from 1 to 30 mass %, more preferably from 10 to 20 mass % as calculated as SiO₂ based on the total amount of the charged starting materials, though its choice depends on the stirring efficiency, the crystal growth rate, the yield, etc.

The total silica concentration of the charged liquid means the total silica concentration in the system and includes, not only silica in the form of the silica source, but also silica brought in the system in the form of sodium silicate or the like used as an alkali metal salt.

The conversion of the silica hydrogel to silica-X and/or silica-Y by the hydrothermal treatment may be promoted by incorporation of an alkali metal salt to the silica source because a pH shift of the charged liquid towards the alkaline side increases the solubility of silica moderately to allow faster precipitation attributable to the so-called Ostwald ripening.

The alkali metal salt may be an alkali metal hydroxide, an alkali metal silicate, an alkali metal carbonate or a combination thereof, and is preferably sodium hydroxide or potassium hydroxide.

The alkali metal may be Li, Na, K or the like, or a combination thereof, and is preferably Na or K.

The pH of the system is preferably at least 7, more preferably from 8 to 13, further preferably from 9 to 12.5.

The amount of the alkali metal to the total amount of the alkali metal and the silica, in terms of the silica/alkali metal molar ratio (SiO₂/Me₂O), is preferably within a range of from 4 to 15, more preferably within a range of from 7 to 13.

The hydrothermal treatment of the silica sol and the hydrous silicic acid is carried out preferably at a temperature of from 150 to 250° C., more preferably from 170 to 220° C., so as to increase the reaction rate and to suppress progress of crystallization.

Further, the time for the hydrothermal treatment of the silica hydrosol and the hydrous silicic acid varies depending upon the temperature of the hydrothermal treatment or presence or absence of seed crystals, but usually, it is preferably from 3 to 50 hours, more preferably from 3 to 40 hours, further preferably from 5 to 25 hours.

The hydrothermal treatment of the silica hydrogel is carried out within a temperature range of preferably from 150 to 220° C., more preferably from 160 to 200° C., further preferably from 170 to 195° C.

Further, the time required for the hydrothermal treatment varies depending upon the temperature of the hydrothermal treatment of the silica hydrogel or presence or absence of seed crystals, but usually, it is preferably from 3 to 50 hours, more preferably from 5 to 40 hours, further preferably from about 5 to 25 hours, especially preferably from about 5 to 12 hours.

Though it is not essential, addition of seed crystals in an amount of from about 0.001 to 1 mass %, based on the amount of the silica source charged is preferred to carry out the hydrothermal treatment efficiently and to shorten the treating time. As the seed crystals, silica-X, silica-Y or the like may be used as it is or after pulverization as the case requires.

After completion of the hydrothermal treatment, the product is taken out from the autoclave, filtered and washed with water. The particles after washed with water preferably have a pH of from 5 to 9, more preferably from 6 to 8, in the form of a 10 mass % water slurry.

### [Silica Powder]

The above-formed silica powder contains silica agglomerates having scaly silica particles agglomerated. The silica agglomerates are silica tertiary particles in the form of porous disorderly agglomerates of scaly silica particles which are overlaid one on another. This can be confirmed by observing the silica powder by a scanning electron microscope (hereinafter sometimes referred to as “SEM”).

Here, flaky silica primary particles cannot be identified with a SEM, and scaly silica secondary particles formed by a plurality of silica primary particles arranged and overlaid one on another so that their faces are in parallel with one another, can be identified.

In contrast, flaky silica primary particles thin enough to transmit electron rays partially can be identified with a TEM. Further, silica secondary particles formed by a plurality of such silica primary particles arranged and overlaid one on another so that their faces are in parallel with one another, can be identified. These silica primary particles and silica secondary particles constitute the scaly silica particles.

It is considered to be difficult to peel and isolate the flaky silica primary particles as constituting units one by one from the scaly silica secondary particles. That is, in the layered overlaid structure, the layers of the flaky silica primary particles are integrated by the firm interlayer bonding. Thus, it is considered to be difficult to disintegrate the scaly silica secondary particles into silica primary particles. By the production process (P), it is possible to disintegrate the silica agglomerates into the scaly silica secondary particles and further to disintegrate them into flaky silica primary particles.

The average particle size of the above-formed silica powder is preferably from 7 to 25 μm, more preferably from 7 to 11 μm.

### [Acid Treatment]

The above-obtained silica powder containing silica agglomerates having scaly silica particles agglomerated is subjected to acid treatment at a pH of at most 2, preferably from 1.5 to 2.

By the acid treatment, deflocculation of the silica agglomerates by the subsequent alkali treatment can be promoted, and formation of irregular particles after the wet disintegrating step can be prevented.

Further, by the acid treatment, the alkali metal salt contained in the silica powder can be removed. In a case where the silica powder is formed by the hydrothermal treatment, an alkali metal salt added in the hydrothermal treatment can be removed.

The pH at the time of the acid treatment is at most 2, preferably at most 1.9. By the preliminary acid treatment with a low pH, the silica agglomerates are more likely to be deflocculated and disintegrated in the subsequent alkali treatment and wet disintegrating step.

The acid treatment is not particularly limited, and may be carried out by adding an acidic liquid to a dispersion containing the silica powder (including the dispersion in the form of a slurry; the same applies hereinafter) so that the pH in the system becomes at most 2, optionally with stirring. The acid treatment is preferably carried out at room temperature for at least 8 hours, preferably for from 9 to 16 hours so as to be sufficiently conducted, though it is not particularly limited.

As the acidic liquid, an aqueous solution of sulfuric acid, hydrochloric acid, nitric acid or the like, preferably an aqueous solution of sulfuric acid may be used. The concentration may be adjusted to from 1 to 37 mass %, preferably from 15 to 25 mass %.

The silica concentration of the silica dispersion is preferably from 5 to 15 mass %, more preferably from 10 to 15 mass %. Further, the pH of the silica dispersion is preferably from 10 to 12.

The blend ratio of the silica dispersion and the acidic liquid is not particularly limited so long as the pH becomes at most 2.

The silica dispersion is preferably washed after the acid treatment, whereby a product formed by neutralization of the alkali metal salt included in the hydrothermal treatment by the acid treatment, can be removed.

The washing method is not particularly limited, and it is preferred to carry out washing with water by means of filtration or centrifugal washing.

The silica dispersion after washing may be mixed with water or concentrated to adjust the solid content. Further, in a case where the silica dispersion is recovered as a silica cake e.g. by filtration, water may be added to obtain a dispersion. The pH of the silica dispersion after washing is preferably from 4 to 6.

### [Aluminate Treatment]

The silica powder after the acid treatment may optionally be subjected to aluminate treatment.

By the aluminate treatment, aluminum (Al) can be introduced to the surface of the silica particles in the silica powder to modify the surface to be negatively charged. The negatively charged silica powder has increased dispersibility in an acidic medium.

The aluminate treatment is not particularly limited, and may be carried out in such a manner that an aqueous solution of an aluminate is added to the dispersion containing the silica powder, followed by stirring as the case requires for mixing, and then the mixture is subjected to heat treatment to introduce Al to the surface of the silica particles.

Mixing is carried out for from 0.5 to 2 hours, preferably for from 0.8 to 1.2 hours at a temperature of from 10 to 30° C., preferably from 20 to 35° C.

Heating is preferably carried out under reflux, and is carried out for at least 4 hours, preferably for from 4 to 8 hours at a temperature of from 80 to 110° C., preferably from 90 to 105° C.

The aluminate may, for example, be sodium aluminate, potassium aluminate or the like or a combination thereof, and is preferably sodium aluminate.

The amount of the aluminate, by the molar ratio of the aluminate as calculated as Al₂O₃ based on the amount of the silica powder as calculated as SiO₂, is preferably adjusted to be within a range of from 0.00040 to 0.00160, preferably from 0.00060 to 0.00100.

The aqueous aluminate solution is preferably prepared to have a concentration of from 1 to 3 mass %. The aqueous aluminate solution can be added in an amount of from 5.8 to 80.0 parts by mass, preferably from 15 to 25 parts by mass per 100 parts by mass of SiO₂ in the silica dispersion.

The silica concentration of the silica dispersion is preferably from 5 to 20 mass %, more preferably from 10 to 15 mass %. Further, the pH of the silica dispersion is preferably from 6 to 8.

The silica dispersion after the aluminate treatment may be mixed with water or concentrated to adjust the solid content.

The pH of the silica dispersion after the aluminate treatment is preferably from 6 to 8.

### [Alkali Treatment]

The above acid-treated and as the case requires, aluminate-treated silica powder is subjected to alkali treatment at a pH of at least 8, preferably from 9 to 11 to deflocculate the silica agglomerates.

By the alkali treatment, it is possible to deflocculate the firm bonding of the silica agglomerates to disintegrate the silica agglomerates nearly into individual scaly silica particles.

Here, deflocculation of the silica agglomerates means to apply a charge to the silica agglomerates to disperse the individual silica particles into a medium.

By the alkali treatment, substantially all the silica particles contained in the silica powder may be deflocculated into the individual scaly silica particles, or only part of the silica particles may be deflocculated and the agglomerates may remain. Further, the entire part of the silica agglomerates contained in the silica dispersion may be deflocculated into the individual scaly silica particles, or only a part of the silica agglomerates may be deflocculated, and the agglomerate part may remain. The remaining agglomerates may be disintegrated into the individual scaly silica particles in the subsequent wet disintegrating step.

The pH at the time of the alkali treatment is at least 8, preferably at least 8.5, more preferably at least 9, whereby deflocculation of the silica agglomerates contained in the silica powder can be promoted. Further, even if the silica agglomerates remain after the alkali treatment, the bond of the silica particles of the silica agglomerates can be weakened, whereby the silica agglomerates are likely to be disintegrated into the individual silica particles in the subsequent wet disintegrating step.

The alkali treatment is not particularly limited and may be carried out in such a manner that an alkaline liquid is added to the dispersion containing the silica powder so that the pH became at least 8, followed by stirring as the case requires. Instead of the alkaline liquid, an alkali metal salt and water may separately be added.

The alkali treatment is carried out at a temperature of from 10 to 50° C. for from 1 to 48 hours, preferably from 2 to 24 hours.

The alkali metal salt may be a hydroxide or carbonate of an alkali metal such as Li, Na or K, or a combination thereof, and K, Na or Li is preferred.

As the alkaline liquid, an aqueous solution containing an alkali metal salt of e.g. Li, Na or K may be used. Further, as the alkaline liquid, aqueous ammonia (NH₃OH) may be used. Among them, preferred is potassium hydroxide, sodium hydroxide or lithium hydroxide.

The concentration of the alkali metal salt ((mass of alkali metal salt)/(total mass of moisture and alkali metal salt in silica dispersion)) may be adjusted to from 0.01 to 28 mass %, preferably from 0.04 to 5 mass %, more preferably from 0.1 to 2.5 mass %, in a state where the alkali metal salt is added to the dispersion containing the silica.

The amount of the alkali metal salt is from 0.4 to 2.5 mmol, preferably from 0.5 to 2 mmol per 1 g of the silica in the silica dispersion.

The silica concentration of the silica dispersion is preferably from 3 to 7 mass %, more preferably from 10 to 16 mass %. Further, the pH of the silica dispersion is preferably from 8 to 11, more preferably from 9 to 11.

The blend ratio of the silica dispersion and the alkaline liquid is not particularly limited so long as the pH becomes at least 8.

The average particle size of the silica powder contained in the silica dispersion after the alkali treatment is preferably from 3 to 10 μm, more preferably from 4 to 8.5 μm.

The silica dispersion after the alkali treatment may be mixed with water or concentrated to adjust the solid content. Further, the pH of the silica dispersion after the alkali treatment is preferably from 8.0 to 12.5, more preferably from 9 to 11.

### [Wet Disintegration]

The above alkali-treated silica powder is wet disintegrated to obtain scaly silica particles.

Here, in the silica powder subjected to the alkali treatment, silica agglomerates partly remaining after the silica agglomerates are deflocculated and in addition, silica particles in a state where the silica agglomerates are formed into smaller particles to a certain extent, are contained. By wet disintegrating such a silica powder, the silica particles can further be disintegrated to obtain the individual scaly silica particles. By preliminary alkali treatment, deflocculation of the silica particles in the wet disintegration can be promoted. Thus, it is possible to prevent the silica particles from being not sufficiently disintegrated and remaining as irregular particles.

For the wet disintegration, a wet system pulverizing apparatus (disintegrator) which mechanically stirs grinding material at high speed using a pulverization medium, such as a wet bead mill, a wet ball mill, a thin-film spin system high-speed mixer or an impact grinder (such as a nanomizer) may be used. Particularly, it is preferred to use a wet bead mill and medium beads of alumina or zirconia having a diameter of from 0.2 to 1 mm, whereby the silica powder can be disintegrated and dispersed while the basic laminated structure of the scaly silica particles are not pulverized or broken as far as possible. Further, by the impact grinder, the particles can be disintegrated into further smaller particles, by introducing a dispersion containing the powder into a thin tube of from 80 to 1,000 μm with a pressure applied thereto, to let the particles in the dispersion collide with one another and be dispersed.

The silica powder to be wet disintegrated is preferably supplied to the wet pulverizing apparatus after being diluted with e.g. purified water such as deionized water or distilled water into a dispersion having an appropriate concentration.

The dispersion concentration is preferably from 0.1 to 20 mass %, and considering the disintegration efficiency and the working efficiency by the viscosity increase, more preferably from 0.1 to 15 mass %.

### [Cation Exchange Treatment]

The silica powder after the wet disintegration may optionally be subjected to cation exchange treatment.

By the cation exchange treatment, the cation particularly metal ions contained in the silica powder can be removed.

The cation exchange treatment is not particularly limited and may be carried out in such a manner that a cation exchange resin is added to the silica dispersion containing the silica powder, followed by stirring as the case requires. The cation exchange treatment is carried out for from 0.5 to 24 hours, preferably for from 3 to 12 hours at a temperature of from 10 to 50° C., preferably from 20 to 35° C.

The resin matrix of the cation exchange resin may, for example, be a styrene type such as styrene/divinylbenzene or a (meth)acrylic acid type. Further, the cation exchange resin is preferably a hydrogen type (H-type) cation exchange resin, and may, for example, be a cation exchange resin having sulfonic acid groups, carboxy groups, phosphoric acid groups or the like.

The cation exchange resin may be added in an amount of from 3 to 20 parts by mass per 100 parts by mass of SiO₂ in the silica dispersion.

The silica concentration of the silica dispersion is preferably from 3 to 20 mass %, more preferably from 10 to 20 mass %.

The pH of the silica dispersion is preferably at most 4, more preferably from 2.0 to 3.5.

As described above, scaly silica particles can be obtained.

The scaly silica particles may be used for preparation of the coating liquid of the present invention in a powder state or may be used for preparation of the coating liquid of the present invention as a dispersion as dispersed in a medium.

As the silica dispersion containing the scaly silica particles, the dispersion after the wet disintegration and the cation exchange treatment as the case requires, may be used as it is, or may be used after concentrated or diluted. Further, moisture in the silica dispersion may be removed and an organic solvent is added. The organic solvent may, for example, be an organic solvent mentioned for the after-mentioned liquid medium (C), benzene, toluene, xylene, coal oil or gas oil.

### [Liquid Medium (C)]

The liquid medium (C) is a liquid in which the component (B) is dispersed. The liquid medium (C) may be a solvent in which the component (A) is dissolved. The liquid medium (C) may, for example, be water, an alcohol, a ketone, an ether, a cellosolve, an ester, a glycol ether, a nitrogen-containing compound or a sulfur-containing compound.

The alcohol may, for example, be methanol, ethanol, isopropanol, butanol or diacetone alcohol.

The ketone may, for example, be acetone, methyl ethyl ketone or methyl isobutyl ketone.

The ether may, for example, be tetrahydrofuran or 1,4-dioxane.

The cellosolve may, for example, be methylcellosolve or ethylcellosolve.

The ester may, for example, be methyl acetate or ethyl acetate.

The glycol ether may, for example, be ethylene glycol monoalkyl ether.

The nitrogen-containing compound may, for example, be N,N-dimethylacetamide, N,N-dimethylformamide or N-methylpyrrolidone.

The sulfur-containing compound may, for example, be dimethylsulfoxide.

Such liquid media (C) may be used alone or in combination of two or more.

Since water is necessary for hydrolysis of the alkoxysilane as the component (A), the liquid medium (C) contains at least water unless replacement of the liquid medium is carried out after hydrolysis of the alkoxysilane.

The liquid medium (C) may be a mixture of water with another liquid. Such another liquid may, for example, be above-described alcohol, ketone, ether, cellosolve, ester, glycol ether, nitrogen-containing compound or sulfur-containing compound.

Among above such other liquids, the solvent for the component (A) is preferably an alcohol, particularly preferably methanol, ethanol, isopropyl alcohol or butanol.

The content of the liquid medium (C) is from 93 to 99.7 mass %, preferably from 95 to 99.5 mass % based on the entire amount (100 mass %) of the coating liquid for forming an alkali barrier layer.

### [Optional Component]

The coating liquid of the present invention may contain another component other than the components (A) and (B) as the case requires within a range not to impair the effects of the present invention.

Such another component may, for example, be an ultraviolet absorber, an infrared reflecting/infrared absorbing agent, an antireflecting agent, another functional particles, a surfactant for improving the leveling property, or a metal compound for improving the durability.

The ultraviolet absorber may, for example, be ZnO or TiO₂.

The infrared reflecting/infrared absorbing agent may, for example, be TiO₂, Sb-containing SnOₓ (ATO) or Sn-containing In₂O₃ (ITO).

Another functional particles may, for example, be metal oxide particles other than the component (B), metal particles, pigment particles or resin particles.

A material of the metal oxide particles other than the component (B) may, for example, be Al₂O₃, SiO₂, SnO₂, TiO₂, ZrO₂, ZnO, CeO₂, Sb-containing SnOₓ (ATO), Sn-containing In₂O₃ (ITO) or RuO₂.

A material of the metal particles may, for example, be a metal (such as Ag or Ru) or an alloy (such as AgPd or RuAu).

The pigment particles may, for example, be an inorganic pigment (such as titanium black or carbon black) or an organic pigment.

A material of the resin particles may, for example, be a polyacrylic resin, polystyrene or a melanine resin.

As the shape of the functional particles, spheres, ellipses, needles, plates, rods, circular cones, circular cylinders, cubes, cuboids, diamonds, stars, triangular pyramids, petals and irregular particles may, for example, be mentioned.

The functional particles may be solid particles, hollow particles or porous particles.

The functional particles may be present independently, may be connected in chains, or may be agglomerated.

As the functional particles, one type may be used alone or two or more types may be used in combination.

The surfactant for improving the leveling property may, for example, be a silicone oil surfactant or an acrylic surfactant.

The metal compound for improving the durability may, for example, be a zirconium chelate compound, a titanium chelate compound or an aluminum chelate compound.

The zirconium chelate compound may, for example, be zirconium tetraacetylacetonate or zirconium tributoxystearate.

The titanium chelate compound may, for example, be titanium tetraacetylacetonate.

The aluminum chelate compound may, for example, be aluminum tetraacetylacetonate.

The content of such an optional component in the coating liquid may properly be set considering the coating properties of the coating liquid, necessary functions, etc.

The coating liquid of the present invention may be prepared, for example, by mixing a solution of the component (A) and a dispersion of the component (B) and as the case requires, an additional liquid solvent, an optional component, etc.

### Advantageous Effect

The coating liquid of the present invention is used to form an alkali barrier layer on a glass substrate. Although the details will be described below, the coating liquid of the present invention is applied to a glass substrate and dried, whereby a film in which the component (B) is dispersed in a matrix derived from the component (A) (a condensate of a hydrolyzate of the alkoxysilane) is formed.

The film hardly shrinks at the time of drying and baking, and warpage of the glass substrate by the shrinkage can be suppressed, since the coating liquid of the present invention contains the component (A) and in addition, the component (B) in a predetermined proportion. For example, warpage can be suppressed to be within a sufficiently tolerable range even when the glass substrate after application of the coating liquid is baked at high temperature of at least 600° C. for the purpose of tempering, or even when a thin glass substrate having a thickness of at most 15.0 mm, further at most 0.7 mm is used.

Further, the film has excellent alkali barrier properties even though it contains silica particles as the component (B), and can sufficiently function as an alkali barrier layer.

The reason why the film has excellent alkali barrier properties is not clearly understood, however, it is considered that the component (B) prepared by the hydrothermal preparation method is microcrystalline and has a higher density than the sol-gel silica.

Further, the influence of the component (B) over properties other than the alkali barrier properties of the film is small, and for example, substantially no influence of the component (B) over the transmittance is confirmed.

Further, as compared with a coating liquid containing the component (A) and containing no component (B), the amount of use of the coating liquid of the present invention required to obtain a necessary film thickness is smaller, when both the coating liquids have the same solid content concentration of the component (A) as calculated as SiO₂, and the coating liquid of the present invention is advantageous in view of the cost.

### <Article>

The article of the present invention comprises a glass substrate and an alkali barrier layer formed of the above-described coating liquid of the present invention on the glass substrate.

The article of the present invention may further have another layer different from the alkali barrier layer on the alkali barrier layer. Such another layer can impart an optional function to the article.

### [Glass Substrate]

Glass constituting the glass substrate is not particularly limited and may, for example, be soda lime glass, borosilicate glass, aluminosilicate glass or mixed alkali glass, and may properly be selected depending upon the purpose of use of the article.

Soda lime glass is not particularly limited, and in a case where the article is a window glass for buildings or for vehicles for example, it is preferably one having the following composition as represented by mass percentage based on oxides:

SiO₂: 65 to 75%,

Al₂O₃: 0 to 10%,

CaO: 5 to 15%,

MgO: 0 to 15%,

Na₂O: 10 to 20%,

K₂O: 0 to 3%,

Li₂O: 0 to 5%,

Fe₂O₃: 0 to 3%,

TiO₂: 0 to 5%,

CeO₂: 0 to 3%,

BaO: 0 to 5%,

SrO: 0 to 5%,

B₂O₃: 0 to 15%,

ZnO: 0 to 5%,

ZrO₂: 0 to 5%,

SnO₂: 0 to 3% and

SO₃: 0 to 0.5%.

Mixed alkali glass is preferably one having the following composition as represented by mass percentage based on oxides:

SiO₂: 50 to 75%,

Al₂O₃: 0 to 15%,

MgO+CaO+SrO+BaO+ZnO: 6 to 24% and

Na₂O+K₂O: 6 to 24%.

The glass substrate may be a smooth glass plate formed by float process, or may be figured glass having irregularities on its surface. Further, it may be flat glass or curved glass.

In a case where the article is a cover glass for a solar cell, the glass substrate is preferably a stippled pattern figured glass having irregularities formed on its surface. The figured glass is preferably soda lime glass (white flat glass) having a lower iron content (higher transparency) than soda lime glass (blue flat glass) used for usual window glass or the like.

The thickness of the glass substrate is not particularly limited and may properly be set depending upon the purpose of use of the article.

The thinner the glass substrate, the more warpage of the glass substrate at the time of forming the alkali barrier layer or at the time of baking for tempering tends to be problematic, and the present invention is highly useful in such a case.

Further, in an application in which an improvement in the transmittance is to be aimed, the thinner the glass substrate, the more absorption of light is suppressed, and the higher the transmittance. From such a viewpoint, the thickness of the glass substrate is preferably at most 15.0 mm, more preferably at most 12.0 mm, further preferably at most 7.0 mm, particularly preferably at most 3.2 mm. The lower limit of the thickness of the glass substrate is not particularly limited.

### [Alkali Barrier Layer]

The alkali barrier layer is a layer having an alkali barrier function to suppress transmission of an alkali. By the alkali barrier layer between a glass substrate and another layer, influence of the alkali of the glass substrate over said another layer is suppressed, and the durability of said another layer will improve. For example, in a case where another layer contains a low reflection film such as a silica porous film, it is possible to suppress a decrease in the antireflection performance due to an alkali which forms under wet and heat conditions resulting from sodium contained in the glass, which breaks the porous structure of the silica porous film.

The article of the present invention comprises, as the alkali barrier layer, a film formed of the above-described coating liquid of the present invention.

The process for forming the alkali barrier layer will be described in detail below.

The article of the present invention may have one or more alkali barrier layers. For example, the alkali barrier layer may be a multilayer film having two or more films sequentially formed using at least two types of coating liquids differing in the composition (the type or the amount of components contained) as the coating liquid of the present invention.

The film thickness (the total film thickness in the case of a multilayer film) of the alkali barrier layer is preferably from 40 to 200 nm, more preferably from 60 to 180 nm. When the film thickness of the alkali barrier layer is at least 40 nm, sufficient alkali barrier properties will be obtained, and when it is at most 200 nm, the uniformity of the film will be favorable.

### [Another Layer]

Another layer which the article of the present invention may have on the alkali barrier layer, is not particularly limited and may be an optional layer depending upon required functions, considering the purpose of use of the article.

Said another layer may, for example, be specifically a low reflection film, an electrically conductive film, a colored film, an infrared shielding film, an ultraviolet shielding film or an antistatic film. Said another layer may be a monolayer film or a multilayer film.

In the article of the present invention, said another layer preferably contains a low reflection film. The low reflection film has low alkali durability when it comprises a silica porous film, and the present invention is useful in such a case.

Further, an article having a low reflection film is useful as a cover glass for a solar cell, a display cover glass, a cover glass for communication equipment such as a mobile phone, glass for vehicles or glass for buildings.

The low reflection film is not particularly limited and may, for example, be the same as a low reflection film known as a low reflection film to be formed on the surface of a glass substrate.

As an example of the low reflection film, a silica porous film may be mentioned as described above. “The silica porous film” is a film having a plurality of voids in a matrix containing silica as the main component.

The silica porous film has a relatively low refractive index (reflectance) since the matrix contains silica as the main component. Further, it is excellent in the chemical stability, the adhesion to the glass substrate, abrasion resistance, etc. Further, since the matrix has pores, the film has a low refractive index as compared with a case where a film has no pores.

The matrix containing silica as the main component means that the proportion of silica is at least 60 mass % in the matrix (100 mass %).

The matrix preferably consists substantially of silica. The matrix consisting substantially of silica means that the matrix is composed only of silica except for inevitable impurities (for example, a structure derived from the material, such as a non-hydrolyzable group when a hydrolyzate of an alkoxysilane having the non-hydrolyzable group is used as the matrix precursor).

The matrix may contain a small amount of components other than silica. Such components may be one or more ions and/or a compound such as an oxide (such as a nitrate, a chloride or a chelate compound) selected from the group consisting of Li, B, C, N, F, Na, Mg, Al, P, S, K, Ca, Ti, V, Cr, Mn, Fe, Co, Ni, Cu, Zn, Ga, Sr, Y, Zr, Nb, Ru, Pd, Ag, In, Sn, Hf, Ta, W, Pt, Au, Bi and lanthanoids.

The matrix may contain not only a two-dimensionally polymerized matrix component but also three-dimensionally polymerized nanoparticles. As the composition of the nanoparticles, Al₂O₃, SiO₂, SnO₂, TiO₂, ZnO or ZrO₂ may, for example, be mentioned. The size of the nanoparticles is preferably from 1 to 200 nm. The shape of the nanoparticles is not particularly limited, and spheres, needles, hollow particles, sheets, horn-shaped particles may, for example, be mentioned.

As an example of a preferred silica porous film, a film obtained by applying a coating liquid containing a dispersion medium (a), fine particles (b) dispersed in the dispersion medium (a) and a matrix precursor (c) dissolved or dispersed in the dispersion medium (a) (hereinafter sometimes referred to as an upper layer coating liquid (I)), followed by drying (baking) may be mentioned.

The film is a film having fine particles (b) dispersed in a matrix comprising a baked product (SiO₂) of the matrix precursor (c). In this film, voids are selectively formed around the fine particles (b). By the voids, the refractive index of the entire film is lowered, and an excellent antireflection effect is exhibited. Particularly in a case where the core portion of the fine particles (b) is hollow, a more excellent antireflection effect will be exhibited. The film is advantageous also in that it can be formed at a low cost at a relative low temperature.

The upper layer coating liquid (I) and a method for forming the silica porous film using it will be described in detail below.

The film thickness of the silica porous film is preferably from 50 to 300 nm, more preferably from 80 to 200 nm. When the film thickness of the silica porous film is at least 50 nm, interference of light will occur, and an antireflection performance will be exhibited. When the film thickness of the silica porous film is at most 300 nm, such a film can be formed without cracking.

The film thickness of the silica porous film is measured by a reflectance spectroscopic film thickness meter.

In a case where said another layer contains the low reflection film, said another layer may consists only of the low reflection film or may further have a layer other than the low reflection film. For example, in a case where the low reflection is a silica porous film, as it has significant irregularities on its surface, stains are likely to deposit, and the stains can hardly be removed. Accordingly, an antifouling layer may further be formed on the low reflection film so as to increase antifouling properties of the article.

A material to be used for the antifouling film may, for example, be a water repellent or oil repellent fluorinated compound or an alkyl group-containing compound.

As another example of a preferred another layer in the article of the present invention, an electrically conductive film may be mentioned.

An electrically conductive film means a film having a surface resistance of at most 10¹²Ω/□.

A material of the electrically conductive film may, for example, be Sb-containing SnOₓ (ATO), Sn-containing In₂O₃ (ITO), RuO₂, Ag, Ru, AgPd or RuAu.

The electrically conductive film may be formed by a known method such as a spin coating method, a spray coating method, a dip coating method, a die coating method, a curtain coating method, a screen coating method, an ink jet method, a flow coating method, a gravure coating method, a bar coating method, a flexographic coating method, a slit coating method or a roll coating method.

### (Upper Layer Coating Liquid (I))

The upper layer coating liquid (I) contains a dispersion medium (a), fine particles (b) dispersed in the dispersion medium (a) and a matrix precursor (c) dissolved or dispersed in the dispersion medium (a).

The dispersion medium (a) is a liquid in which the fine particles (b) are dispersed. The dispersion medium (a) may be a solvent in which the matrix precursor (c) is dissolved.

The dispersion medium (a) may be the same medium as the liquid medium (C).

In a case where the matrix precursor (c) is a hydrolyzate of the alkoxysilane, the dispersion medium (a) preferably contains at least water, since water is necessary for hydrolysis. As the dispersion medium (a), water and another liquid may be used in combination. Said another liquid may, for example, be an alcohol, a ketone, an ether, a cellosolve, an ester, a glycol ether, a nitrogen-containing compound or a sulfur-containing compound. Among the above other liquids, the solvent for the matrix precursor (c) is preferably an alcohol, particularly preferably methanol, ethanol, isopropyl alcohol or butanol.

The fine particles (b) may, for example, be metal oxide fine particles, metal fine particles, pigment fine particles or resin fine particles.

A material of the metal oxide fine particles may, for example, be Al₂O₃, SiO₂, SnO₂, TiO₂, ZrO₂, ZnO, CeO₂, Sb-containing SnOₓ (ATO), Sn-containing In₂O₃ (ITO) or RuO₂, and is preferably SiO₂ in view of a low refractive index.

A material of the metal fine particles may, for example, be a metal (such as Ag or Ru) or an alloy (such as AgPd or RuAu).

The pigment fine particles may, for example, be an inorganic pigment (such as titanium black or carbon black) or an organic pigment.

A material of the resin fine particles may, for example, be a polyacrylic resin, polystyrene or a melanine resin.

As the shape of the fine particles (b), spheres, ellipses, needles, plates, rods, circular cones, circular cylinders, cubes, cuboids, diamonds, stars, triangular pyramids, petals and irregular particles may, for example, be mentioned. Further, the fine particles (b) may be hollow or porous. Further, the fine particles (b) may be present independently, may be connected in chains, or may be agglomerated.

The average agglomerated particle size of the fine particles (b) is preferably from 1 to 1,000 nm, more preferably from 3 to 500 nm, further preferably from 5 to 300 nm.

When the average agglomerated particle size of the fine particles (b) is at least 1 nm, a sufficiently high antireflection effect will be obtained. When the average agglomerated particle size of the fine particles (b) is at most 1,000 nm, the haze of the silica porous film 14 tends to be suppressed.

The average agglomerated particle size of the fine particles (b) is an average agglomerated particle size of the fine particles (b) in the dispersion medium (a) and is measured by a dynamic light scattering method. In the case of monodispersed fine particles not agglomerated, the average agglomerated particle size is equal to the average primary particle size.

As the fine particles (b), one type may be used alone, or two or more types may be used in combination.

The matrix precursor (c) may, for example, be a hydrolyzate (sol-gel silica) of an alkoxysilane or silazane, and is preferably the hydrolyzate of an alkoxysilane.

The alkoxysilane may be the same alkoxysilane as described for the component (A). The hydrolyzate is obtained by hydrolyzing the alkoxysilane in the same manner as the method described for the component (A). A catalyst to be used for hydrolysis is preferably one which will not inhibit dispersion of the fine particles (b).

The upper layer coating liquid (I) may further contains a terpene derivative (d), whereby a volume of voids in the silica porous film to be formed will be increased, and the antireflection effect will be higher.

A terpene is a hydrocarbon having a composition (C₅H₈)ₙ (wherein n is an integer of at least 1) having isoprene (C₅H₈) as a constituting unit.

The terpene derivative (d) means a terpene having a functional group derived from terpene. The terpene derivative (d) includes derivatives differing in the degree of unsaturation.

Further, some terpene derivatives (d) function as the dispersion medium (a). However, “a hydrocarbon having a composition (C₅H₈)ₙ having isoprene as a constituting unit” corresponds to the terpene derivative (d) and is considered not to correspond to the dispersion medium (a).

The terpene derivative (d) is, in view of an antireflection effect of the silica porous film 14, preferably a terpene derivative having a hydroxy group and/or a carbonyl group in its molecule, more preferably a terpene derivative having at least one member selected from the group consisting of a hydroxy group, an aldehyde group (—CHO), a keto group (—C(═O)—), an ester bond (—C(═O)O—) and a carboxy group (—COOH) in its molecule, further preferably a terpene derivative having at least one member selected from the group consisting of a hydroxy group, an aldehyde group and a keto group in its molecule.

The terpene derivative (d) may, for example, be a terpene alcohol (such as α-terpineol, terpinen-4-ol, L-menthol (±)citronellol, myrtenol, nerol, borneol, farnesol or phytol), a terpene aldehyde (such as citral, β-cyclocitral or perillaldehyde), a terpene ketone (such as (±) camphor or β-ionone), a terpene carboxylic acid (such as citronellic acid or abietic acid), a terpene ester (terpinyl acetate or menthyl acetate). It is particularly preferably a terpene alcohol.

The terpene derivative (d) may be used alone or in combination of two or more.

The upper layer coating liquid (I) may contain another additive as the case requires.

Such another additive may, for example, be a surfactant for improving the leveling property, or a metal compound for improving the durability of the silica porous film 14.

The surfactant may, for example, be a silicone oil type or an acrylic type.

The metal compound is preferably a zirconium chelate compound, a titanium chelate compound, an aluminum chelate compound or the like. The zirconium chelate compound may, for example, be zirconium tetraacetylacetonate or zirconium tributoxystearate.

The viscosity of the upper layer coating liquid (I) is preferably from 1.0 to 10.0 mPa·s, more preferably from 2.0 to 5.0 mPa·s. When the viscosity of the upper layer coating liquid (I) is at least 1.0 mPa·s, the film thickness of the silica porous film to be formed is likely to be controlled. When the viscosity of the upper layer coating liquid (I) is at most 10.0 mPa·s, the drying or baking time after application of the upper layer coating liquid (I) or the application time is shortened. The viscosity of the upper layer coating liquid (I) is measured by a B type viscometer.

The solid content concentration of the upper layer coating liquid (I) is preferably from 1 to 9 mass %, more preferably from 2 to 6 mass %. When the solid content concentration is at least 1 mass %, the coating film of the upper layer coating liquid (I) can be made thin, and the film thickness of the silica porous film to be finally obtained tends to be uniform. When the solid content concentration is at most 9 mass %, the film thickness of the coating film of the upper layer coating liquid (I) tends to be uniform.

The solid content of the upper layer coating liquid (I) means the sum of the fine particles (b) and the matrix precursor (c) (provided that the solid content of the matrix precursor (c) is the amount of the alkoxysilane as calculated as SiO₂).

The mass ratio (fine particles/matrix precursor) of the fine particles (b) to the matrix precursor (c) in the upper layer coating liquid (I) is preferably from 95/5 to 10/90, more preferably from 70/30 to 90/10. When the fine particles/matrix precursor mass ratio is at most 95/5, the adhesion between the silica porous film and the glass substrate tends to be sufficiently high. When the fine particles/binder mass ratio is at least 10/90, the antireflection effect tends to be sufficiently high.

In a case where the terpene derivative (d) is incorporated in the upper layer coating liquid (I), its amount is preferably from 0.01 to 2 parts by mass, more preferably from 0.03 to 1 part by mass per 1 part by mass of the solid content of the upper layer coating liquid (I). When the amount of the terpene derivative (d) is at least 0.01 part by mass, the antireflection effect will be sufficiently high as compared with a case where the terpene derivative (d) is not added. When the amount of the terpene derivative is at most 2 parts by mass, the strength of the silica porous film tends to be favorable.

The upper layer coating liquid (I) may be prepared, for example, by mixing a dispersion of the fine particles (b), a solution of the matrix precursor (c) and as the case requires, an additional dispersion medium (a), the terpene derivative (d) and another additive.

### [Process for Producing Article]

The article of the present invention may be produced, for example, by applying the coating liquid of the present invention to a glass substrate, followed by drying (baking) to form an alkali barrier layer, and as the case requires, forming another layer on the alkali barrier layer.

It is preferred to carry out baking treatment at from 80 to 700° C., preferably at from 100 to 700° C., for the purpose of densification of the alkali barrier layer, physical tempering of the glass substrate, etc., at the time of forming the alkali barrier layer or after its formation (for example, at the time of forming another layer or after its formation). To carry out the baking treatment is preferred also in view of usefulness of the present invention.

As a method of applying the coating liquid of the present invention to a glass substrate, a known wet coating method may be employed. For example, a spin coating method, a spray coating method, a dip coating method, a die coating method, a curtain coating method, a screen coating method, an ink jet method, a flow coating method, a gravure coating method, a bar coating method, a flexographic coating method, a slit coating method or a roll coating method may, for example, be mentioned.

The liquid temperature of the coating liquid at the time of application is preferably from room temperature to 80° C., more preferably from room temperature to 60° C.

Application and drying (baking) of the coating liquid may be carried out by applying the coating liquid, followed by heating to an optional drying temperature, or may be carried out by applying the coating liquid to a glass substrate preliminarily heated to a drying (baking) temperature.

The drying (baking) temperature is preferably at least 30° C., and is properly determined depending upon the glass substrate and the material (the component (A) and the like) of the coating liquid.

The alkali barrier layer is preferably baked at a temperature of at least 80° C. The baking temperature is more preferably at least 100° C., more preferably from 200 to 700° C. When the baking temperature is at least 80° C., the hydrolyzate of the alkoxysilane can be quickly formed into a baked product. Particularly when the baking temperature is at least 100° C., the baked product is densified and has improved durability.

In a case where another layer is further formed on the alkali barrier layer, baking of the alkali barrier layer may be carried out before formation of such another layer or may be carried out after formation. For example, in a case where baking is carried out at the time of forming another layer, the step of baking said another layer may function also as the step of baking the alkali barrier layer.

A step of forming another layer on the alkali barrier layer may be carried out by a known method depending upon another layer to be formed.

For example, in a case where the above-described upper layer coating liquid (I) is used, the liquid is applied to the alkali barrier layer and dried (baked) to form a low reflection film comprising the silica porous film.

Application and drying (baking) of the upper layer coating liquid (I) may be carried out in the same manner as the application and drying (baking) of the coating liquid of the present invention. Preferred conditions are also the same.

The step of baking the alkali barrier layer or the silica porous film may function also as a step of physically tempering the glass substrate. In the physical tempering step, the glass substrate is heated to the vicinity of the softening temperature of glass. In such a case, the baking temperature is set at from about 600 to about 700° C. The baking temperature is usually set to be at most the heat distortion temperature of the glass substrate. The lower limit of the baking temperature is determined depending upon e.g. the blend ratio of a coating liquid.

However, since polymerization of the hydrolyzate of the alkoxysilane proceeds to a certain extent even by air drying, it is theoretically possible to set the drying or baking temperature to a temperature in the vicinity of room temperature, if there is not restriction on time.

### Advantageous Effects

The article of the present invention comprises a glass substrate and an alkali barrier layer formed of the coating liquid of the pre on the glass substrate.

By the alkali barrier layer being formed of the coating liquid of the present invention, in the article of the present invention, shrinkage of the film at the time of drying (baking) after application of the coating liquid and warpage of the glass substrate due to shrinkage are suppressed. The warpage is sufficiently small even when high temperature baking for physical tempering of the glass substrate is carried out. Accordingly, the article of the present invention is less likely to be subjected to the restrictions on the tempering conditions, a decrease in the yield of products by warpage more than the tolerable range is less likely to occur, and the article of the present invention is excellent in the productivity.

Further, the alkali barrier layer has excellent alkali barrier properties. Accordingly, the article having such an alkali barrier layer between the glass substrate and another layer is excellent in the durability since a decrease in the function of said another layer by an alkali from the glass substrate is less likely to occur.

The application of the article of the present invention is not particularly limited, and for example, an article having a low reflection film as another layer may be used as a cover glass for a solar cell, a display cover glass, a cover glass for communication equipment such as a mobile phone, a glass for vehicles or glass for buildings.

### EXAMPLES

Now, the present invention will be described in further detail with reference to Examples. However, it should be understood that the present invention is by no means restricted to such specific Examples.

Among the following Examples, Ex. 2 to 7 are Examples of the present invention, and Ex. 1 and 8 to 11 are Comparative Examples.

Measurement/evaluation methods and materials (manufacturers or preparation methods) used in the following Examples are shown below.

### [Measurement/Evaluation Methods]

### (Method of Measuring Aspect Ratio)

The maximum length of scaly silica actually measured from a transmission electron microscope (TEM) photograph was divided by the minimum average thickness measured by an atomic force microscope (AFM) to obtain the aspect ratio.

Further, the average aspect ratio was an average of optionally 50 aspect ratios obtained by the above method.

### (Measurement of Warpage)

An article for warpage measurement (an article having a lower layer (alkali barrier layer) formed on a glass substrate) was placed on a horizontal plate so that the lower layer faced upward, and the height (mm) from the lower side of the plate to the upper part of the top of the substrate was measured by a micrometer. The total thickness (3.4 mm) of the plate and the substrate was subtracted from the measured value, and the obtained value was taken as the warpage (mm).

### (Evaluation of High Temperature and High Humidity Resistance)

In an environmental test chamber (manufactured by ESPEC CORP., PR-1SP), a glass substrate and an article for film property measurement (an article having a lower layer (alkali barrier layer) and an upper layer (low reflection film) formed on a glass substrate) were set and left to stand at 90° C. under a humidity of 95% RH for 168 hours. Then, the respective transmittances of the glass substrate and the article for film property measurement taken out were measured by the following procedure. The difference in transmittance Td was obtained from the measured values in accordance with the following formula (1):

Td=T1−T2 (1)

In the formula (1), T1 is the transmittance of the article for film property measurement, and T2 is the transmittance of the glass substrate alone.

### (Transmittance)

The transmittance (%) of each of the glass substrate and the article for film property measurement was measured by a spectrophotometer (manufactured by JASCO Corporation, V670) with respect to light at a wavelength of from 400 to 1,100 nm. The light incident angle was 5°.

### [Material]

(Matrix precursor solution (α-1))

A mixture of 11.9 g of deionized water and 0.1 g of 61 mass % nitric acid was added to 80.4 g of denatured ethanol (manufactured by Japan Alcohol Trading Co., Ltd., SOLMIX AP011 (tradename), a solvent mixture containing ethanol as the base compound, hereinafter “denatured ethanol” means this mixture) with stirring, followed by stirring for 5 minutes. 7.6 g of tetraethoxysilane (solid content concentration: 29 mass %) was added to the mixture, followed by stirring at room temperature for 30 minutes to prepare a matrix precursor solution (α-1) having a solid content concentration of 2.2 mass %.

The solid content concentration is a solid content concentration as calculated as SiO₂ (solid content concentration assuming that the entire Si in the tetraethoxysilane is converted to SiO₂).

### (Matrix Precursor Solution (α-2))

A mixture of 11.9 g of deionized water and 0.1 g of 61 mass % nitric acid was added to 77.6 g of denatured ethanol with stirring, followed by stirring for 5 minutes. 10.4 g of tetraethoxysilane (solid content concentration as calculated as SiO₂: 29 mass %) was added to the mixture, followed by stirring at room temperature for 30 minutes to prepare a matrix precursor solution (α-2) having a solid content concentration as calculated as SiO₂ of 3.0 mass %.

The obtained matrix precursor solution (α-2) was used for preparation of the after-mentioned coating liquid (L) for an upper layer (low reflection film).

### (Scaly Silica Particle Dispersion (β))

### “Preparation of Silica Dispersion”

The silica hydrogen as the starting material was prepared using sodium silicate as an alkali source as follows. An aqueous sodium silicate solution of SiO₂/Na₂O=3.0 (molar ratio) having a SiO₂ concentration of 21.0 mass %, at 2,000 mL/min, and an aqueous sulfuric acid solution having a sulfuric acid concentration of 20.0 mass %, were introduced into a container equipped with a nozzle from different inlets and uniformly mixed instantaneously, while the flow rates of the two solutions were adjusted so that the pH of the liquid ejected from the nozzle into the air would be from 7.5 to 8.0, and the uniformly mixed silica sol liquid was continuously ejected from the nozzle into the air. The discharged liquid was formed into spherical droplets in the air and gelled in the air while it was flying in the air for about 1 second forming a parabola, and let to dive into an aging tank containing water placed at their landing site and aged.

After aging, the pH was adjusted to 6, and the gel was further sufficiently washed with water to obtain a silica hydrogel. The obtained silica hydrogen particles were spherical and had an average particle size of 6 mm. The mass ratio of water based on the mass of SiO₂ in the silica hydrogen particles was 4.55 times.

The silica hydrogen particles were roughly pulverized to an average particle size of 2.5 mm by a double roll crusher and subjected to the subsequent hydrothermal treatment.

Into an autoclave (equipped with an anchor type agitating blade) having a capacity of 17 m³, 7,249 kg of the silica hydrogel (SiO₂: 18 mass %) having a particle size of 2.5 mm and 1,500 kg of an aqueous sodium silicate solution (SiO₂: 29.00 mass %, Na₂O: 9.42 mass %, SiO₂/Na₂O=3.18 (molar ratio)) were charged so that the total SiO₂/Na₂O molar ratio in the system would be 12.0, and 1,560 kg of water was added, and 4,682 kg of high pressure water vapor having a saturation pressure of 17 kgf/cm² was added with stirring at 10 rpm, followed by heating to 185° C., and then hydrothermal treatment was carried out for 5 hours. The total silica concentration in the system was 12.5 mass % as SiO₂.

The silica dispersion after preparation was filtered and washed to collect the silica powder, which was observed with a transmission electron microscope (TEM) and as a result, the silica dispersion was confirmed to contain silica agglomerates. Further, the average particle size of the silica particles as measured by a laser diffraction/scattering type particle size distribution measuring apparatus (manufactured by Horiba, Ltd., “LA-950”, the same applies hereinafter) was 8.33 μm.

### “Acid Treatment”

To 10,100 g of the silica dispersion after preparation (solid content measured by an infrared moisture meter: 13.3 mass %, pH: 11.4) with stirring by a stirrer, 1,083 g of an aqueous sulfuric acid solution having a sulfuric acid concentration of 20 mass % was added. The pH after addition was 1.5. Stirring was continued at room temperature for 18 hours to carry out the treatment.

### “Washing”

The silica dispersion after the acid treatment was subjected to filtration washing with water in an amount of 50 mL per 1 g of the silica. The silica cake after washed was recovered and mixed with water to prepare a slurry. The solid content of the silica dispersion measured by an infrared moisture meter was 14.7 mass %, and the pH was 4.8.

### “Aluminate Treatment”

7,000 g of the silica dispersion after washed was put in a 10 L flask, and 197 g (Al₂O₃/SiO₂ molar ratio: 0.00087) of a 2.02 mass % aqueous sodium aluminate solution was added little by little with stirring by an overhead stirrer. The pH after addition was 7.2. After addition, stirring was continued at room temperature for 1 hour. Then, the mixture was heated and treated for 4 hours under heat reflux conditions.

### “Alkali Treatment”

To 775 g of the silica dispersion after the aluminate treatment, 43.5 g (1 mmol/g-silica) of potassium hydroxide and 1,381 g of water were added with stirring by a stirrer. The pH after addition was 9.9. Stirring was continued as it was at room temperature for 24 hours to carry out the treatment. The average particle size of the silica particles after the alkali treatment was 7.98 μm.

### “Wet Disintegration”

The silica dispersion after the alkali treatment was treated using an ultra-high pressure wet disintegration apparatus (manufactured by YOSHIDA KIKAI CO., LTD., “Nanomizer NM2-2000AR”, pore size 120 μm, collision-type generator) under a discharge pressure of from 130 to 140 MPa for 30 passes to disintegrate the silica particles. The pH of the silica dispersion after disintegration was 9.3, and the average particle size measured by a laser diffraction/scattering type particle size distribution measuring apparatus was 0.182 μm.

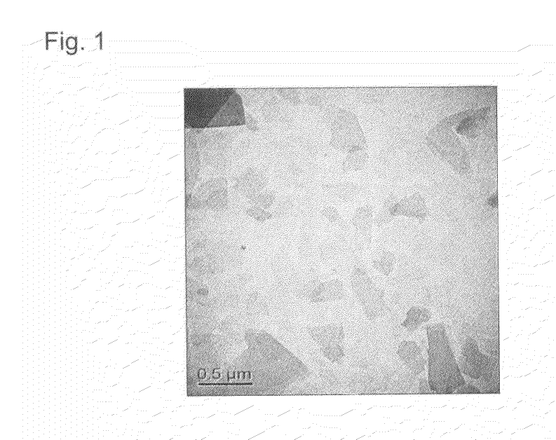

The silica dispersion after wet disintegration was filtrated and washed, and the silica powder was collected and observed with a transmission electron microscope (TEM), and the results are shown in FIG. 1. As shown in FIG. 1, the silica dispersion was confirmed to contain scaly silica particles.

### “Cation Exchange”

161 mL of a cation exchange resin was added to 1,550 g of the silica dispersion after disintegration, followed by treatment at room temperature for 17 hours with stirring by an overhead stirrer. Then, the cation exchange resin was separated. The pH of the silica dispersion after the cation exchange was 3.7.

The silica particles were taken out from the obtained silica dispersion (scaly silica particle dispersion (β)) and their shape was observed with a TEM and as a result, it was confirmed that the silica particles were only scaly silica particles containing substantially no irregular particles.

The average particle size of the silica particles contained in the scaly silica particle dispersion (β) was 0.182 μm, which was the same as that after the wet disintegration. The average aspect ratio was 188.

The solid content of the scaly silica particle dispersion (β) measured by an infrared moisture meter was 3.6 mass %.

### (Spherical Silica Fine Particle Dispersion (γ))

SNOWTEX OS (tradename) manufactured by Nissan Chemical Industries, Ltd., solid content concentration as calculated as SiO₂: 20.5 mass %, average primary particle size: 8 to 10 nm.

(Spherical silica fine particle dispersion (δ))

SNOWTEX O (tradename) manufactured by Nissan Chemical Industries, Ltd., solid content concentration as calculated as SiO₂: 20.5 mass %, average primary particle size: 10 to 20 nm.

### (Coating Liquid (A) for Lower Layer (Alkali Barrier Film))

The matrix precursor solution (α-1) was used as it was as a coating liquid (A) for a lower layer having a solid content concentration as calculated as SiO₂ of 2.2 mass %.

### (Coating Liquid (B) for Lower Layer (Alkali Barrier Film))

To 95.0 g of the matrix precursor solution (α-1) with stirring, 2.8 g of denatured ethanol and 2.2 g of the scaly silica particle dispersion (β) were added to prepare a coating liquid (B) for a lower layer having a solid content concentration of 2.2 mass %.

### (Coating Liquids (C) to (K) for Lower Layer (Alkali Barrier Film))

Coating liquids (C) to (K) for a lower layer having a solid content concentration of 2.2 mass % were prepared in the same manner as the formation of the coating liquid (B) for a lower layer except that the compositions were as identified in Table 1.

### (Coating Liquid (L) for Upper Layer (Low Reflection Film))

To 16.5 g of denatured ethanol with stirring, 24.0 g of isobutyl alcohol, 15.0 g of diacetone alcohol, 1.0 g of β-ionone, 30.0 g of the matrix precursor solution (α-2) and 13.5 g of the chain solid silica fine particle dispersion (γ) were added to prepare a coating liquid (L) for an upper layer having a solid content concentration as calculated as SiO₂ of 3.0 mass %.

### Ex. 1

### Polishing and Washing of Glass Substrate

As glass substrates, soda lime glass (manufactured by Asahi Glass Company, Limited, FL0.7 (tradename), size: 100 mm×100 mm, thickness: 0.7 mm) and figured glass (manufactured by Asahi Glass Company, Limited, Solite (tradename), low iron content soda lime glass (white plate glass), size: 100 mm×100 mm, thickness: 3.2 mm) were prepared. The surface of each glass was polished with an aqueous cerium oxide dispersion for 3 minutes, and cerium oxide was washed off with water, and the glass substrate was rinsed with deionized water and dried. Warpage at the time of completion of drying was 0.

### (Preparation of Article for Warpage Measurement)

The above soda lime glass was preheated in a preheating furnace (manufactured by Isuzu Seisakusho, VTR-115) at 80° C. and disposed on a spin coater (manufactured by MIKASA CO., LTD., 1H-360S) in a state where the temperature of the polished surface was maintained at 30° C. Then, the polished surface of the substrate was spin-coated with 1 mL of the coating liquid (A) for a lower layer dropped thereon by a plastic dropper, followed by baking in the air at 650° C. for 10 minutes to obtain an article for warpage measurement (an article having a monolayer structure of an alkali barrier layer).

Warpage was measured with respect to the obtained article for warpage measurement. The results are shown in Table 1.

### (Preparation of Article for Film Property Measurement)

The figured glass was preheated by a preheating furnace (manufactured by Isuzu Seisakusho, VTR-115) at 80° C. and disposed on a spin coater (manufactured by MIKASA CO., LTD., 1H-360S) in a state where the temperature of the polished surface was maintained at 30° C. Then, the polished surface of the substrate was spin-coated with 1 mL of the coating liquid (A) for a lower layer dropped thereon by a plastic dropper, and further spin-coated with 1 mL of the coating liquid (L) for an upper layer dropped thereon by a plastic dropper, followed by baking in the air at 600° C. for 10 minutes to obtain an article for film property measurement (an article having a two-layer structure of an alkali barrier layer/a low reflection film).

The high temperature and high humidity resistance was evaluated with respect to the obtained article for film property measurement. The results are shown in Table 1.

### Ex. 2 to 11

Two types of articles (an article for warpage measurement and an article for film property measurement) were obtained in the same manner as in Ex. 1 except that the coating liquid for a lower layer was as identified in Table 1. Warpage was measured with respect to the article for warpage measurement, and the high temperature and high humidity resistance was evaluated with respect to the article for film property measurement. The results are shown in Table 1.

In Table 1, “particle/matrix precursor” means the mass ratio of the silica particles (scaly or spherical) to the matrix precursor in the coating liquid for a lower layer by solid content.

TABLE 1

| | | | Ex. 1 | Ex. 2 | Ex. 3 | Ex. 4 | Ex. 5 | Ex. 6 |
|---|---|---|---|---|---|---|---|---|
| Coating | Type | | A | B | C | D | E | F |
| liquid | Composition | Matrix precursor solution (α-1) | 100.0 | 95.0 | 90.0 | 71.4 | 60.0 | 80.0 |
| for | (g) | Denatured ethanol (AP-11) | | 2.8 | 5.6 | 16.0 | 22.4 | 11.2 |
| lower | | Scaly silica particle dispersion (β) | | 2.2 | 4.4 | 12.6 | 17.6 | 8.8 |
| layer | | Spherical silica particle dispersion (γ) | | | | | | |
| | | Spherical silica particle dispersion (δ) | | | | | | |
| | | Total | 100.0 | 100.0 | 100.0 | 100.0 | 100.0 | 100.0 |

| | | | | | | |
|---|---|---|---|---|---|---|
| Particle/matrix precursor (mass ratio by solid content) | 0/100 | 5/95 | 10/90 | 28.6/71.4 | 60/40 | 80/20 |

| | | | | | | |
|---|---|---|---|---|---|---|
| Type of coating liquid for upper layer | L | L | L | L | L | L |
| Warpage (mm) | 4.42 | 4.17 | 3.58 | 2.74 | 3.13 | 3.66 |
| Difference in transmittance Td (%) | 0.17 | 0.40 | 0.19 | 0.30 | 0.28 | 0.35 |

| | | | Ex. 7 | Ex. 8 | Ex. 9 | Ex. 10 | Ex. 11 |
|---|---|---|---|---|---|---|---|
| Coating | Type | | G | H | I | J | K |
| liquid | Composition | Matrix precursor solution (α-1) | 90.0 | 90.0 | 71.4 | 50.0 | 90.0 |
| for | (g) | Denatured ethanol (AP-11) | 5.6 | 8.9 | 25.5 | 44.6 | 8.9 |
| lower | | Scaly silica particle dispersion (β) | 4.4 | | | | |
| layer | | Spherical silica particle dispersion (γ) | | 1.1 | 3.1 | 5.4 | |
| | | Spherical silica particle dispersion (δ) | | | | | 1.1 |
| | | Total | 100.0 | 100.0 | 100.0 | 100.0 | 100.0 |

| | | | | | |
|---|---|---|---|---|---|
| Particle/matrix precursor (mass ratio by solid content) | 90/10 | 10/90 | 28.6/71.4 | 50/50 | 10/90 |

| | | | | | |
|---|---|---|---|---|---|
| Type of coating liquid for upper layer | L | L | L | L | L |
| Warpage (mm) | 3.79 | 4.48 | 4.41 | 4.97 | 4.84 |
| Difference in transmittance Td (%) | 0.32 | 0.86 | 0.69 | 1.03 | 0.77 |

As evident from the above results, in Ex. 2 to 7, warpage of the articles for warpage measurement was smaller than that of the article for warpage measurement in Ex. 1 in which the matrix precursor solution (α-1) was used as it was as the coating liquid for a lower layer, and warpage at the time of high temperature baking was suppressed.

Further, the articles for film property measurement in Ex. 2 to 7 had a small difference in transmittance Td of at most 0.5%. Accordingly, it was confirmed that the lower layers formed of the coating liquids (B) to (G) for a lower layer had sufficient alkali barrier properties, and influence of the alkali over the low reflection film at high temperature under high humidity can be suppressed.

Whereas in Ex. 8 to 11 in which the coating liquid for a lower layer containing spherical silica particles instead of scaly silica particles was used, warpages of the articles for warpage measurement were equal to or larger than the warpage of the article for warpage measurement in Ex. 1. Further, the differences in transmittance Td of the articles for film property measurement exceeded 0.5%.

### INDUSTRIAL APPLICABILITY

The article comprising a glass substrate and an alkali barrier layer formed of the coating liquid of the present invention on the glass substrate, has small warpage of the glass substrate even by high temperature baking, is produced with high productivity due to a reduction in a decrease of the product yield, hardly undergoes a decrease in the function due to excellent alkali barrier properties, and is excellent in the durability and is thereby useful as a cover glass for a solar cell, a display cover glass, a cover glass for communication equipment such as a mobile phone, glass for vehicles or glass for buildings.

This application is a continuation of PCT Application No. PCT/JP2014/050579 filed on Jan. 15, 2014, which is based upon and claims the benefit of priority from Japanese Patent Application No. 2013-004618 filed on Jan. 15, 2013. The contents of those applications are incorporated herein by reference in their entireties.

What is claimed is:

1. A coating liquid for forming an alkali barrier layer, which comprises at least one matrix precursor (A) selected from the group consisting of an alkoxysilane and its hydrolyzate, scaly silica particles (B) and a liquid medium (C),
wherein the proportion of the content (solid content) of the scaly silica particles (B) is from 5 to 90 mass % based on the total amount of the matrix precursor (A) and the scaly silica particles (B).

2. The coating liquid for forming an alkali barrier layer according to claim 1, wherein the alkoxysilane is a compound represented by the following formula:
SiXₘY₄₋ₘ
wherein m is an integer of from 2 to 4, X is an alkoxy group, and Y is a non-hydrolyzable group.

3. The coating liquid for forming an alkali barrier layer according to claim 1, wherein the scaly silica particles (B) have an average aspect ratio of from 50 to 650 and an average particle size of from 0.08 to 0.42 μm.

4. The coating liquid for forming an alkali barrier layer according to claim 1, wherein the scaly silica particles (B) are flaky silica primary particles having a thickness of from 0.001 to 0.1 μm, or silica secondary particles having a thickness of from 0.001 to 3 μm, formed by a plurality of flaky silica primary particles arranged and overlaid one on another so that their faces are in parallel with one another.

5. The coating liquid for forming an alkali barrier layer according to claim 3, wherein the scaly silica particles (B) are produced by a process comprising a step of subjecting a silica powder containing silica agglomerates having scaly silica particles agglomerated to acid treatment at a pH of at most 2, a step of subjecting the acid-treated silica powder to alkali treatment at a pH of at least 8 to deflocculate the silica agglomerates, and a step of wet disintegrating the alkali-treated silica powder.

6. The coating liquid for forming an alkali barrier layer according to claim 1, wherein the liquid medium (C) is at least one member selected from the group consisting of water, an alcohol, a ketone, an ether, a cellosolve, an ester, a glycol ether, a nitrogen-containing compound and a sulfur-containing compound.

7. The coating liquid for forming an alkali barrier layer according to claim 1, wherein the content of the matrix precursor (A) as the solid content concentration (as calculated as SiO₂) is from 0.03 to 6.3 mass % based on the total mass of the coating liquid for forming an alkali barrier layer.

8. The coating liquid for forming an alkali barrier layer according to claim 1, wherein the total amount of the matrix precursor (A) and the scaly silica particles (B) as the solid content concentration (as calculated as SiO₂) is from 0.3 to 7 mass % based on the total mass of the coating liquid for forming an alkali barrier layer.

9. An article, which comprises a glass substrate, and an alkali barrier layer formed of the coating liquid for forming an alkali barrier layer as defined in claim 1 on the glass substrate.

10. The article according to claim 9, wherein the alkali barrier layer has a film thickness of from 40 to 200 nm.

11. The article according to claim 9, wherein the glass substrate has a thickness of at most 15.0 mm.

12. The article according to claim 9, which further has another layer different from the alkali barrier layer on the alkali barrier layer.

13. The article according to claim 12, wherein said another layer contains a low reflection film.

14. The article according to claim 9, which is subjected to baking treatment at from 100 to 700° C. at the time of forming or after forming the alkali barrier layer.
